(19) United States
(12) Patent Application Publication
(10) Pub. No.: US 2026/0213519 A1
(43) Pub. Date: Jul. 23, 2026

(54) VARIABLE DIFFERENTIAL CURRENT STABILIZING DEVICE FOR HIGH-IMPEDANCE DIFFERENTIAL PROTECTION SCHEMES

(71) Applicant: Saudi Arabian Oil Company, Dhahran (SA)

(72) Inventors: Nabil El Halabi Fares, Dhahran (SA); Abdulaziz Yahya Hannani, Dhahran (SA); Ricardo Jose Guerra Castillo, Madrid (ES); Sultan Al Ghamdi, Dhahran (SA)

(21) Appl. No.: 19/033,899

(22) Filed: Jan. 22, 2025

(51) Int. Cl. H02H 1/04; H02H 3/08; H02H 3/32

(52) U.S. Cl. CPC H02H 1/04; H02H 3/08; H02H 3/32

(57) ABSTRACT

System and method for implementing a current stabilizing device to interface with high-impedance differential protection scheme. An example stabilizing device includes a voltmeter configured to detect faults in a current protection system; one or more shunt resistors, the one or more shunt resistors arranged in the stabilizing device to limit current flow to an overcurrent relay when there are no faults in a electrical system; one or more stabilizing resistors, the one or more stabilizing resistors arranged in the stabilizing device to stabilize the current to the overcurrent relay when there are faults in the electrical system; and one or more stacks of metrosils configured to protect the overcurrent relay from high voltage when there are faults in the electrical system.

### TECHNICAL FIELD

This description relates to a differential current stabilizing device for high-impedance differential protection systems.

### BACKGROUND

A high-impedance differential protection system is a type of protective setup that uses a high-impedance resistor to prevent false trips caused by small current differences or external issues. This resistor ensures the relay only activates if there is a real problem inside the protected area, like a short-circuit within a busbar or transformer winding. By filtering out minor electrical noise and current transformer errors, this system detects true internal faults and avoids unnecessary interruptions.

### SUMMARY

Certain aspects of the subject matter described here can be implemented as a current stabilizing device to interface with high-impedance differential protection scheme. The current stabilizing device comprises: a voltmeter configured to detect faults in a current protection system; one or more shunt resistors, the one or more shunt resistors arranged in the current stabilizing device to limit current flow to an overcurrent relay when there are no faults in an electrical system; one or more stabilizing resistors, the one or more stabilizing resistors arranged in the stabilizing device to stabilize the current to the overcurrent relay when there are faults in the electrical system; and one or more stacks of metrosils configured to protect the overcurrent relay from high voltage when there are faults in the electrical system.

The current stabilizing device can include one or more of the following features.

In some implementations, the current stabilizing device further comprises a switch configured to operate an external circuit breaker to interrupt the flow of electrical power to an electrical system when there is a detected fault in the electrical system.

In some implementations, the current stabilizing device is connected to a plurality of current transformers configured to measure currents on either side of the switch.

In some implementations, the overcurrent relay is configured to monitor a difference between the currents on either side of the switch and use the difference to detect that there is a fault in the electrical system.

In some implementations, the current stabilizing device comprises two stacks of metrosils.

In some implementations, the one or more shunt resistors are variable resistors.

In some implementations, the one or more stabilizing resistors are variable resistors.

In some implementations, the variable resistors values range from 100 ohms to 3000 ohms.

In some implementations, the overcurrent relay is a high-impedance differential relay.

Stabilizing a differential current protection system requires a number of stabilizing elements that are implemented separately and limited to specific values that do not always cover the intended application. The systems and methods described in this specification utilize single modular device for stabilization. By integrating a supervision element, one or more shunt resistors, one or more stabilizing resistors, and metrosils into a single device, a differential current protection system can independently adjust the wiring connection, current transformer supervision and the values of the stabilizing resistors and metrosils from an overcurrent relay.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE DRAWINGS

FIG. 1 shows an example differential current protection system, according to some implementations.

FIG. 2 illustrates a flowchart of an example method, according to some implementations.

FIG. 3 illustrates a flowchart of an example method, according to some implementations.

### DETAILED DESCRIPTION

Stabilizing a differential current protection system requires a number of stabilizing elements. In existing systems however, such stabilizing elements are implemented separately and limited to specific values that do not always cover the intended application. Existing stabilizing strategies include implementing additional accessories to meet desired protection requirements. These strategies are cumbersome to implement because it is difficult to adjust the values of the stabilizing elements when they are not properly selected for differential protection, resulting in current transformer saturation or erroneous operation.

This disclosure describes systems and methods for performing high impedance differential protection using a single modular device for stabilization. Among other examples, the systems and methods can be used to protect an electrical system from internal faults (e.g., short circuits, insulation failures, open circuit faults, ground faults, wiring problems within a device or system, line-to-line faults within a component, etc.).

By integrating a supervision element, one or more shunt resistors, one or more stabilizing resistors, and metrosils into a single device, the differential current protection system can independently adjust the secondary current magnitude, current transformer supervision, and the values of the stabilizing resistors and metrosils for an external overcurrent relay.

Integrating variable stabilizing resistors and variable shunt resistors into a stabilizing device ensures that wide rated parameters of current transformers, such as ratio, accuracy class, can be adjusted adequately to avoid current transformer saturation or sensitive values before connecting it to the overcurrent protection relay. Any short-circuit modification or current transformer replacement that interfaces with an overcurrent relay requires a new calculation with new values to ensure protection scheme remains dependable and reliable. Instead of removing fixed resistors or procuring new resistors as needed, the stabilizing device allows for adjustment in the main parameters.

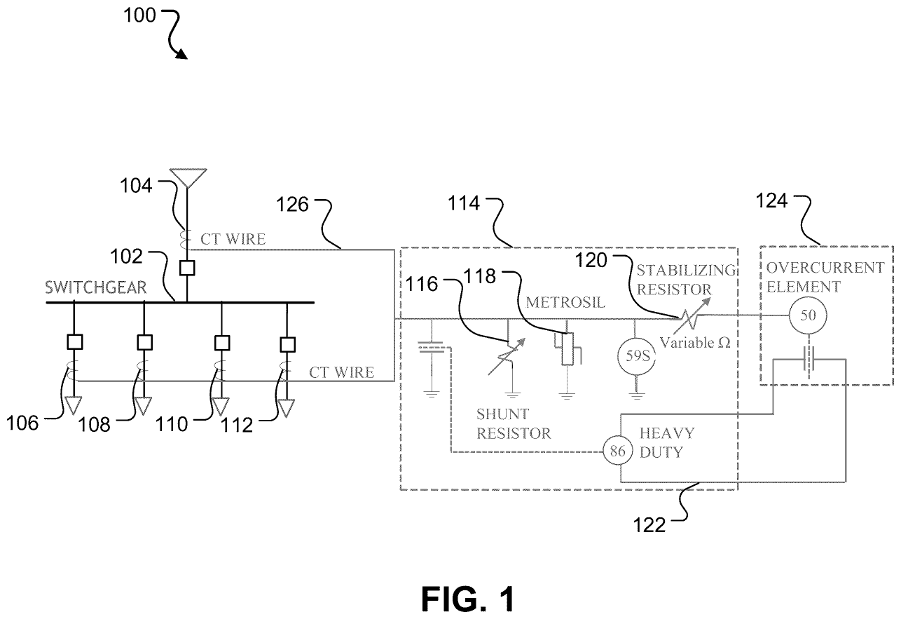

FIG. 1 shows an example differential current protection system for protecting an electrical system, according to some implementations.

The electrical system can include switchgear 102 that distributes the flow of electrical power to downstream connected equipment. The switchgear 102 can include a combination of electrical devices. The electrical devices can include, for example, circuit breakers, fuses, and switches that are used to control, protect, and isolate electrical equipment. The switchgear 102 can be protected from damage caused by internal faults.

The electrical system can be divided into multiple protection zones. Each protection zone can cover one or more pieces of electrical equipment.

On either side of the switchgear 102, one or more current transformers 104, 106, 108, 110, and 112 along a current transformer wire 126 are connected to measuring the current flowing through the switchgear of equipment. The current transformers 104, 106, 108, 110, and 112 detect internal faults by measuring currents on either side of the switchgear 102 for a protection zone. The differential current protection system 100 compares the current measured on either side of the switchgear.

The current transformers 104, 106, 108, 110, and 112 are connected to an overcurrent relay 124 that monitors the differential current between the currents on either side of the switchgear. The differential current is the difference between the currents on either side of the switchgear 102. When there are no significant internal faults, the differential current is negligible as the currents entering and leaving the protection zone are balanced. No significant current flows through the overcurrent relay. When these currents are balances, the system is stable. However, when there is one or more internal fault within the protection zone, the system generates a differential current.

The overcurrent relay protects electrical circuits from excessive currents that could cause damage, injuries, or faults. The overcurrent relay 124 compares the differential current to a predetermined threshold (e.g., 13 Amps, 15 amps, etc.). The relay 124 can open the circuit if the current exceeds the predetermined threshold. Additionally, the relay can, for example, trip the circuit breaker, provide an alarm, or record fault data.

The overcurrent 124 relay can be, for example, used in a high-impedance differential current protection scheme. A high-impedance differential current scheme uses an overcurrent relay with a high impedance circuit to stabilize the summation of the secondary current provided by each current transformers. This causes small differential currents to generate a significant voltage across the relay. When the voltage exceeds a predetermined threshold, the relay can send a trip signal to a lockout relay that ensures that the circuit breakers are tripped. This prevents further damage or instability. When there are no faults or faults outside zone of protection of the switchgear 102, the high impedance ensures that the differential current is too small to trigger the relay.

To ensure stable connections between the overcurrent relay 124 and the current transformers 104, 106, 108, 110, and 112, the system can use a stabilizing device 114. The stabilizing device 114 can connect two or more current transformers with an associated overcurrent relay. The stabilizing 114 device can be hosted in a metallic box that is compatible with typical relay panels of switchgear compartments.

The stabilizing 114 device can include a supervision element 122, one or more shunt resistors 116, one or more scheme stabilizing resistors 120, and one or more metrosils 118.

The supervision element 122 can monitor the functionality of the protection system. The supervision element 122 can detect issues that affect the protection system's ability to detect and isolate faults. The issue can be, for example, current transformer wiring failures or open circuits. If the supervision element 122 detects an issue, the supervision element can block the overcurrent relay from operating to prevent false tripping.

The supervision element 122 can be based on a voltmeter device that measures the voltage between each phase to ground. The voltmeter device can be analog or digital. When there are no faults, the voltage is negligible. However, when there is a sustained voltage measurement above a predetermined threshold, the supervision element detects that there is a deficient or open current transformer or defective wiring in the specific phase. The supervision element 122 can alert an operator of the protection system for troubleshooting. The supervision element 122 can be configured to defeat the protection in that specific phase until it returns to healthy conditions.

The supervision element 122 can be an integrated voltmeter that measures the voltage between phase and ground on each of three-phase wires. Upon the measured voltage exceeding a preset threshold, the device can be configured to operate heavy-duty contacts. The heavy-duty contacts short the phase to ground. This avoids potential maloperation of the overcurrent relay and alerts operators about current transformer supervision deficiencies.

The one or more shunt resistors 116 limit current flow during normal conditions. This ensures that the differential current protection system only limits current flow when a real fault is detected. The one or more shunt resistors 116 can be variable resistors, e.g., rheostats.

The one or more scheme stabilizing resistors 120 help the overcurrent relay 124 to remain stable when faults are detected outside the protection zone. When the current transformers 104, 106, 108, 110, and 112 are exposed to high external fault currents, the system can face current transformer saturation. The stabilizing resistors 120 limit the current flowing through the overcurrent relay 124 to ensure that it does not trip unnecessarily.

The stabilizing resistors 120 can be determined based on having current transformers of a high accuracy class (e.g., C200) and a low current transformer ratio (e.g., 800/5). The one or more stabilizing resistors 120 can be variable resistors, e.g., rheostats. The variable resistors can, for example, range from 100 ohms to 3000 ohms.

The one or more metrosils 118 are voltage limiting devices. The metrosils 118 protect the relay 124 from excessive voltage that can be generated during internal faults. The stabilizing device 114 can include at least two parallel stacks of metrosils 118 to accommodate dissipated energy. Using two stacks of metrosils 118 can accommodate PX accuracy class current transformers. PX accuracy class current transformers are designed to minimize false differential currents. These types of current transformers are typically used in extra high voltage conditions (e.g., 230 kilovolts). The resulting peak voltages require high energy discharge ratings.

The stabilizing device 114 can integrate stacks of metrosils 118 to clamp voltage peak values to not exceed a predetermined threshold (e.g., 1500 volts). The stabilizing device 114 can include metal-oxide varistors that are selected to meet the clamping voltage at the predetermined threshold. The varistors can also limit dissipation energy to not exceed a predetermined threshold (e.g., 100 kilojoules).

Typically, each element in the stabilizing device 114 is implemented separately. The components are limited to a specific value that does not always cover the intended application. Users can implement additional accessories to meet desired protection requirements. By integrating the supervision element 122, the one or more shunt resistors 116, the one or more stabilizing resistors 120, and the metrosils 118 into a single device, the differential current protection system 100 can independently adjust the wiring connection and current transformer supervision and the values of the stabilizing resistors and metrosils from the overcurrent relay.

During both normal operating conditions and fault conditions, including fixed resistors that are not properly selected for the differential protection can result in current transformer saturation or erroneous operation. Integrating variable stabilizing resistors and variable shunt resistors into a stabilizing device ensures that wide rated parameters of current transformers, such as ratio, accuracy class, can be adjusted adequately to avoid current transformer saturation or sensitive values before connecting it to the overcurrent protection relay.

Any short-circuit modification or current transformer replacement that interfaces with an overcurrent relay requires a new calculation with new values to ensure protection scheme remains dependable and reliable. Instead of removing fixed resistors or procuring new resistors as needed, the stabilizing device allows for adjustment in the main parameters (e.g., the stabilizing resistors, the shunt resistors and metrosils).

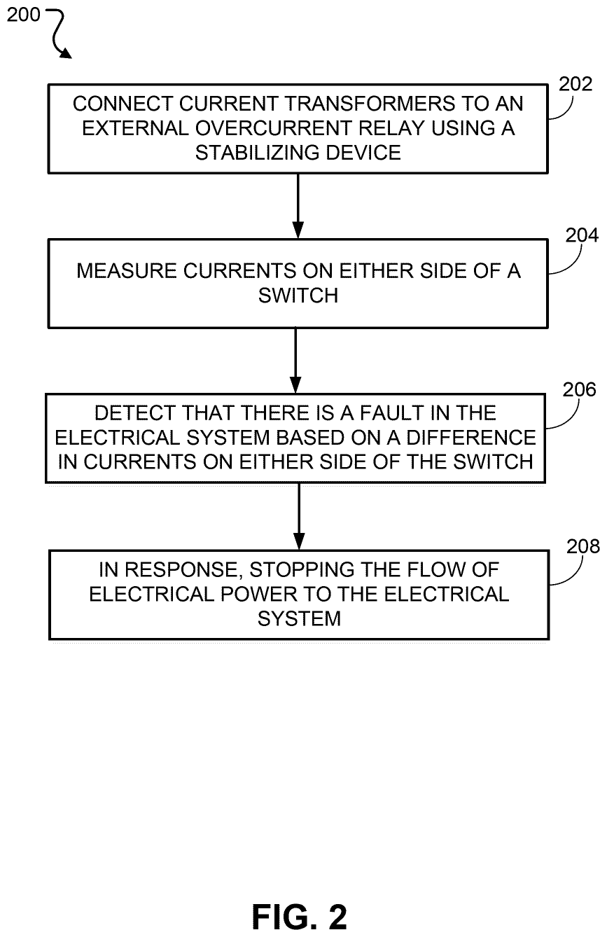

FIG. 2 illustrates a flowchart of an example method 200, according to some implementations. For clarity of presentation, the description that follows generally describes method 200 in the context of the other figures in this description. For example, method 200 can be performed by the differential current protection system 100 of FIG. 1. It will be understood that method 200 can be performed, for example, by any suitable system, environment, software, hardware, or a combination of systems, environments, software, and hardware, as appropriate. In some implementations, various steps of method 200 can be run in parallel, in combination, in loops, or in any order.

The system can connect one or more current transformers to an overcurrent relay using a stabilizing device (step 202). The stabilizing device can include a voltmeter, one or more shunt resistors, one or more stabilizing resistors, and one or more stacks of metrosils. The voltmeter can be configured to detect faults in the system. The one or more shunt resistors can be arranged in the stabilizing device to limit current flow to an overcurrent relay when there are no faults in the electrical system. The one or more stabilizing resistors can be arranged in the stabilizing device to stabilize the current to the overcurrent relay when there are faults in the electrical system. The one or more stacks of metrosils can be configured to protect the overcurrent relay from high voltage when there are faults in the electrical system.

The system can measure currents on either side of a switch configured to stop the flow of electrical power to an electrical system using the one or more current transformers (step 204).

The system can detect that there is a fault in the electrical system (step 206). The system can use the overcurrent relay to determine a difference between the currents on either side of the switch. If the difference is above a predetermined threshold, the system can detect that there is a fault.

In response to detecting that there is a fault in the electrical system, the system can stop the flow of electrical power to the electrical system (step 208). The system can use the switch to stop the flow of electrical power.

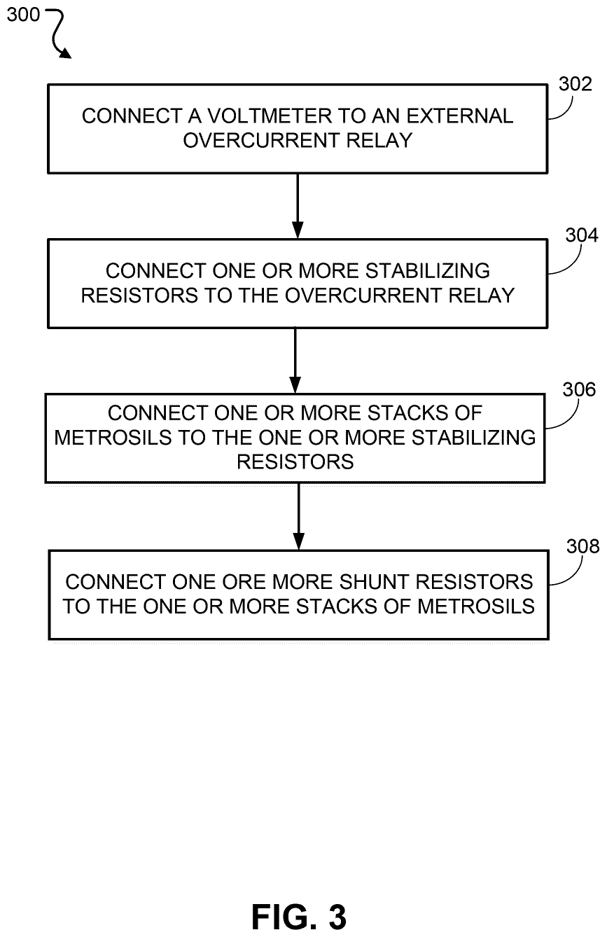

FIG. 3 illustrates a flowchart of an example method 300, according to some implementations, for manufacturing a current stabilizing device. For clarity of presentation, the description that follows generally describes method 300 in the context of the other figures in this description. It will be understood that method 300 can be performed, for example, by any suitable system, environment, software, hardware, or a combination of systems, environments, software, and hardware, as appropriate. In some implementations, various steps of method 200 can be run in parallel, in combination, in loops, or in any order.

The system can connect a voltmeter configured to detect faults in a current protection system to an external overcurrent relay (step 302)

The system can connect one or more stabilizing resistors to the overcurrent relay (step 304). The one or more stabilizing resistors can be arranged in the stabilizing device to stabilize the current to the overcurrent relay when there are faults in an electrical system.

The system can connect one or more stacks of metrosils to the one or more stabilizing resistors (step 306). The one or more stacks of metrosils can be configured to protect the overcurrent relay from high voltage when there are faults in the electrical system.

The system can connect one or more shunt resistors to the one or more stacks of metrosils (step 308). The one or more shunt resistors can be arranged in the current stabilizing device to limit current flow to an overcurrent relay when there are no faults in the electrical system.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Moreover, the separation or integration of various system modules and components in the previously described implementations should not be understood as requiring such separation or integration in all implementations; and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A current stabilizing device to interface with high-impedance differential protection scheme, the current stabilizing device comprising:
a voltmeter configured to detect faults in a current protection system;
one or more shunt resistors, the one or more shunt resistors arranged in the current stabilizing device to limit current flow to an overcurrent relay when there are no faults in an electrical system;
one or more stabilizing resistors, the one or more stabilizing resistors arranged in the stabilizing device to stabilize the current to the overcurrent relay when there are faults in the electrical system; and
one or more stacks of metrosils configured to protect the overcurrent relay from high voltage when there are faults in the electrical system.

2. The current stabilizing device of claim 1, further comprising:
a switch configured to operate an external circuit breaker to interrupt the flow of electrical power to an electrical system when there is a detected fault in the electrical system.

3. The current stabilizing device of claim 2, wherein the current stabilizing device is connected to a plurality of current transformers configured to measure currents on either side of the switch.

4. The current stabilizing device of claim 3, wherein the overcurrent relay is configured to monitor a difference between the currents on either side of the switch and use the difference to detect that there is a fault in the electrical system.

5. The current stabilizing device of claim 1 wherein the current stabilizing device comprises two stacks of metrosils.

6. The current stabilizing device of claim 1, wherein the one or more shunt resistors are variable resistors.

7. The current stabilizing device of claim 1, wherein the one or more stabilizing resistors are variable resistors.

8. The current stabilizing device of claim 5, wherein the variable resistors values range from 100 ohms to 3000 ohms.

9. The current stabilizing device of claim 4, wherein the overcurrent relay is a high-impedance differential relay.

10. A method for stabilizing a measured current from a plurality of current transformers connected in parallel to an external overcurrent relay, the method comprising:
connecting, using a stabilizing device, the plurality of current transformers to an external overcurrent relay, wherein the stabilizing device comprises:
a voltmeter configured to supervise current transformers connection and differential current stability;
one or more shunt resistors, the one or more shunt resistors arranged in the stabilizing device to provide flexibility to adjust sensitivity for detecting electrical faults in an electrical system;
one or more stabilizing resistors, the one or more stabilizing resistors arranged in the stabilizing device to stabilize the current to the overcurrent relay when there are faults in the electrical system; and
one or more stacks of metrosils configured to protect the overcurrent relay from high voltage when there are faults in the electrical system;
measuring, using the plurality of current transformers, currents on either side of a switch;
detecting, using the overcurrent relay, that there is a fault in the electrical system based on a difference between the currents on either side of the switch; and
in response to detecting that there is a fault in the electrical system, stopping, using the switch, the flow of electrical power to the electrical system.

11. The method of claim 10, wherein the stabilizing device comprises two stacks of metrosils.

12. The method of claim 10, wherein the one or more shunt resistors are variable resistors.

13. The method of claim 10, wherein the one or more stabilizing resistors are variable resistors.

14. The method of claim 13, wherein the variable resistors values range from 100 ohms to 3000 ohms.

15. The method of claim 10, wherein the overcurrent relay is a high-impedance differential relay.

16. A method of manufacturing a current stabilizing device, the method comprising
connecting a voltmeter configured to detect faults in a current protection system to an external overcurrent relay;
connecting one or more stabilizing resistors to the overcurrent relay, the one or more stabilizing resistors arranged in the stabilizing device to stabilize the current to the overcurrent relay when there are faults in an electrical system;
connecting one or more stacks of metrosils to the one or more stabilizing resistors, the one or more stacks of metrosils configured to protect the overcurrent relay from high voltage when there are faults in the electrical system; and
connecting one or more shunt resistors to the one or more stacks of metrosils, the one or more shunt resistors arranged in the current stabilizing device to limit current flow to an overcurrent relay when there are no faults in the electrical system.

17. The method of claim 16, wherein the stabilizing device comprises two stacks of metrosils.

18. The method of claim 16, wherein the one or more shunt resistors are variable resistors.

19. The method of claim 16, wherein the one or more stabilizing resistors are variable resistors.

20. The method of claim 19, wherein the variable resistors values range from 100 ohms to 3000 ohms.
